(19) United States
(12) Patent Application Publication
(10) Pub. No.: US 2017/0316703 A1
(43) Pub. Date: Nov. 2, 2017

(54) Method of Recording Milestone Observations of Medical Resident Education and Calculating Achievement Levels

(71) Applicants: Marc Lowell Schneider, Canton, OH (US); Roger Musa, Canton, OH (US); Keith Brian Werstler, Canton, OH (US)

(72) Inventors: Marc Lowell Schneider, Canton, OH (US); Roger Musa, Canton, OH (US); Keith Brian Werstler, Canton, OH (US)

(73) Assignee: Aultman Innovations, LLC, Canton, OH (US)

(21) Appl. No.: 15/581,026

(22) Filed: Apr. 28, 2017

Related U.S. Application Data
(60) Provisional application No. 62/328,668, filed on Apr. 28, 2016.

(51) Int. Cl. G09B 5/00; G06Q 10/10; G06Q 50/20; G09B 19/00

(52) U.S. Cl. CPC G09B 5/00; G09B 19/00; G06Q 10/10; G06Q 50/20

(57) ABSTRACT

A method of recording observations and calculating achievement levels is disclosed. Specifically, the method is used by two mobile applications working in conjunction with a live database on a remote server. The server communicates with the database which holds a number of tables that are related and sortable, and can be accessed by both applications. These applications read and write to the same database allowing for the sharing of data in real time. The first mobile application is used by faculty educators in residency programs or medical schools and allows for the input of resident or student data relating to the observation of milestones. The second application is used by medical residents or students to access their milestone observations and is used as a live report card documenting their current level of attainment. The live database is server based and is accessed by both the faculty/teacher and learner applications.

### CROSS-REFERENCE

This application claims priority from Provisional Patent Application Ser. No. 62/328,668 filed Apr. 28, 2016.

### BACKGROUND

The present invention relates generally to a method of timely recording observations and calculating achievement levels of an individual such as a medical resident. Preferably, the method is performed by a mobile application working in conjunction with a remote server. The server communicates with a database that contains a number of tables that are related and sortable.

The Accreditation Council of Graduate Medical Education (ACGME) mandates that resident or student data relating to the observation of certain milestones be provided to the resident/student. Typically, such information is reported to the resident/student in a written report. The resident/student reports are purely text-based, and the text of the report is a typed or automatic transcription of a recorded voice narration, which is then reported to the resident/student after a significant period of time has passed.

Therefore, the current reporting method is both time consuming and susceptible to errors, such as typographical errors, dictation errors, etc. Further, the current reporting method oftentimes results in the resident/student not receiving the necessary report until a significant amount of time has passed since the occurrence of the observation giving rise to the report, which is undesirable. Accordingly, residents/students would benefit from an electronic report card that allows students and teachers to process observations in real time, or substantially less time than the current method takes.

The present invention aims to provide a new and useful method for recording observations and calculating achievement levels. The method utilizes two mobile applications working in conjunction with a live database on a remote server. These applications read and write to the same database allowing for the sharing of data in real time or substantially real time. More specifically, the first mobile application is used by teachers for the input of observations.

The second application is used by students, such as medical residents, to access their milestone observations, and may also be used as a real time report card that documents the resident/student's current level of attainment.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a method of recording observations and calculating achievement levels. Specifically, the method utilizes two mobile applications working in conjunction with a live database stored on a remote server. The server communicates with the database which stores a number of tables that are related and sortable, and can be accessed by both mobile applications. These applications read and write to the same database allowing for the sharing of data in real time or substantially real time.

The first mobile application is used by faculty educators in residency programs or medical schools and allows for the input of resident or student data relating to the observation of milestones as required by each residency specialty as mandated by the ACGME. The second application is used by medical residents or students to access their milestone observations and is used as a live report card documenting their current level of attainment. These two applications also interact with each other via push notifications. This method is applicable to faculty, educators, residents, residencies, medical students, medical schools, and medical education, as well as other educational and training settings.

The live database is server based and is accessed by both the faculty/teacher and student applications. This database is also accessible to licensed individuals via a web-based administrative site. The database is unique in its customization features and allows for the full functionality of the applications as described herein. Individual programs or schools have access only to their secure database, whether using the web-based administration and customization website, or the mobile applications licensed to their particular institution and/or users.

The administrative site allows each program to determine the minimum number of observations required for each milestone level in order to achieve “competency”. The administrative site also has a feature that allows each program to manually establish sub-competency levels for any resident/student. This feature is particularly useful for establishing the initial baseline for senior residents and transfer residents who have already achieved some milestones and/or a particular level of competence.

In a preferred embodiment of the present invention, general observations are not counted for completion of a particular milestone level. Rather, the general observations are used to provide constructive criticism to the resident/student for the particular sub-competency that it was recorded under.

In a preferred embodiment of the present invention, specific observations are recorded under a particular milestone description. Further, milestones are organized by level and each level requires a minimum number of observations to be considered complete. This grading practice is preferably done in accordance with guidelines set forth by the ACGME.

To calculate an achievement score for a particular resident/student, the observation table is sorted for those coded to that resident and for that particular sub-competency by milestone level. The resulting data is then walked-through by milestone level and tested against the minimum required observations for that particular milestone level. If the minimum observations for a particular level have been satisfied, the algorithm continues to walk through the data. However, at the first level where there is a shortfall between the number of observations and the number required to achieve that particular level, the system will then calculate a fractional achievement score. The fractional achievement score is then added to the score(s) of the previously achieved levels to calculate an overall achievement score for the resident/student.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of a screen shot of the student and competency screens of the first application of the present invention in accordance with the disclosed architecture.

FIG. 2 illustrates a perspective view of a screen shot of the milestones screens of the first application of the present invention in accordance with the disclosed architecture.

FIG. 3 illustrates a perspective view of a screen shot of the checkout screen of the first application of the present invention in accordance with the disclosed architecture.

FIG. 4 illustrates a perspective view of a screen shot of the sub-competencies and milestones screens of the first application of the present invention in accordance with the disclosed architecture.

FIG. 5 illustrates a perspective view of a screen shot of a sub-competencies screen of the first application of the present invention in accordance with the disclosed architecture.

FIG. 6 illustrates a perspective view of a screen shot of a competencies screen of the first application of the present invention in accordance with the disclosed architecture.

FIG. 7 illustrates a perspective view of a screen shot of the milestone searching feature associated with a competencies screen of the first application of the present invention in accordance with the disclosed architecture.

FIG. 8 illustrates a perspective view of a screen shot of the milestone screen of the first application of the present invention in accordance with the disclosed architecture.

FIG. 9 illustrates a perspective view of a screen shot of one student screen of the first application of the present invention in accordance with the disclosed architecture.

FIG. 10 illustrates a perspective view of a screen shot of a second student screen of the first application of the present invention in accordance with the disclosed architecture.

FIG. 11 illustrates a perspective view of a screen shot of the milestone screens of the first application of the present invention in accordance with the disclosed architecture.

FIG. 12 illustrates a perspective view of a screen shot of the resident-view and observations screens of the first application of the present invention in accordance with the disclosed architecture.

FIG. 13 illustrates a perspective view of a screen shot of the resident-report screens of the first application of the present invention in accordance with the disclosed architecture.

FIG. 14 illustrates a perspective view of a screen shot of additional resident-report screens of the first application of the present invention in accordance with the disclosed architecture.

FIG. 15 illustrates a perspective view of a screen shot of the resident and observations screens of the second application of the present invention in accordance with the disclosed architecture.

FIG. 16 illustrates a perspective view of a screen shot of the observation-detail screens of the second application of the present invention in accordance with the disclosed architecture.

FIG. 17 illustrates a perspective view of a screen shot of the sub-competencies and competencies screens of the second application of the present invention in accordance with the disclosed architecture.

FIG. 18 illustrates a perspective view of a screen shot of the milestones screen of the second application of the present invention in accordance with the disclosed architecture.

FIG. 19 illustrates a perspective view of a screen shot of the resident-report screens of the second application of the present invention in accordance with the disclosed architecture.

FIG. 20 illustrates a perspective view of a screen shot of additional resident-report screens of the second application of the present invention in accordance with the disclosed architecture.

FIG. 21 illustrates a perspective view of the app-details screen of the second application of the present invention in accordance with the disclosed architecture.

FIG. 22 illustrates a graphical representation of the hierarchical relationships between the various table types of the present invention in accordance with the disclosed architecture.

FIG. 23 illustrates a method of using the present invention to record an observation.

FIG. 24 illustrates a method of using the present invention to calculate achievement scores for sub-competencies.

FIG. 25 illustrates a perspective view of a generic computer device and a generic mobile computer device that can be used in conjunction with the present invention.

FIG. 26 illustrates a perspective view of a generic server system that can be used in conjunction with the present invention.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

A method of recording observations and calculating achievement levels is disclosed. Specifically, the method utilizes a mobile application working in conjunction with a remote server. The server communicates with a database that holds a number of tables that are both related and sortable.

This method of recording milestone observations disclosed utilizes two mobile applications accessible on both Apple iOS and Android platforms and a live database on servers accessed by both applications. These applications read and write to the same database allowing for the sharing of data in real time or substantially real time. The first mobile application is used by faculty educators, for example, in residency programs or medical schools and allows for the input of resident or student data relating to the observation of milestones as required by each residency specialty as mandated by The Accreditation Council of Graduate Medical Education (ACGME). The second application is used by medical residents or students to access their milestone observations, and is used as a live report card documenting their current level of attainment. These two applications also interact with each other via push notifications. This method is applicable to faculty, educators, residents, residencies, medical students, medical schools, and medical education, as well as in other educational and/or training settings. When mentioned below, educator, teacher, and faculty are interchangeable and all represent the same person. Learner, student, and resident are also interchangeable and all represent the same person.

The live database is server based and is accessed by both the faculty/teacher and learner applications. This database is also accessible to licensed individuals via the web-based administrative site. This web-based access allows for the addition of faculty, learners, photos, email addresses, phone numbers and other information. It also allows the program or school to customize the application features. The database is unique in its customization features allowing for the full functionality of the applications as described. Individual programs or schools have access only to their secure database, whether using the web-based administration and customization site, or the mobile applications licensed to their institution and users.

The administrative site allows each program to determine the minimum number of observations required for each milestone level in order to achieve “competency” for that particular milestone level. The administrative site also has a feature that allows each program to manually establish sub-competency levels for any resident. This particular feature is useful for establishing the initial baseline for senior residents and transfer residents who have already achieved some milestones.

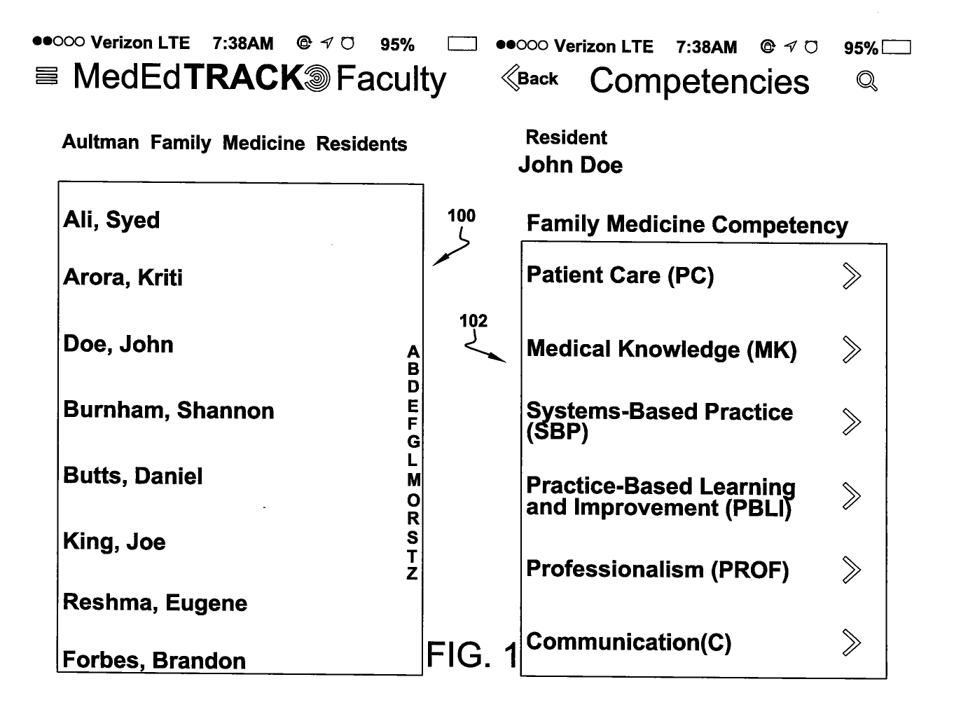

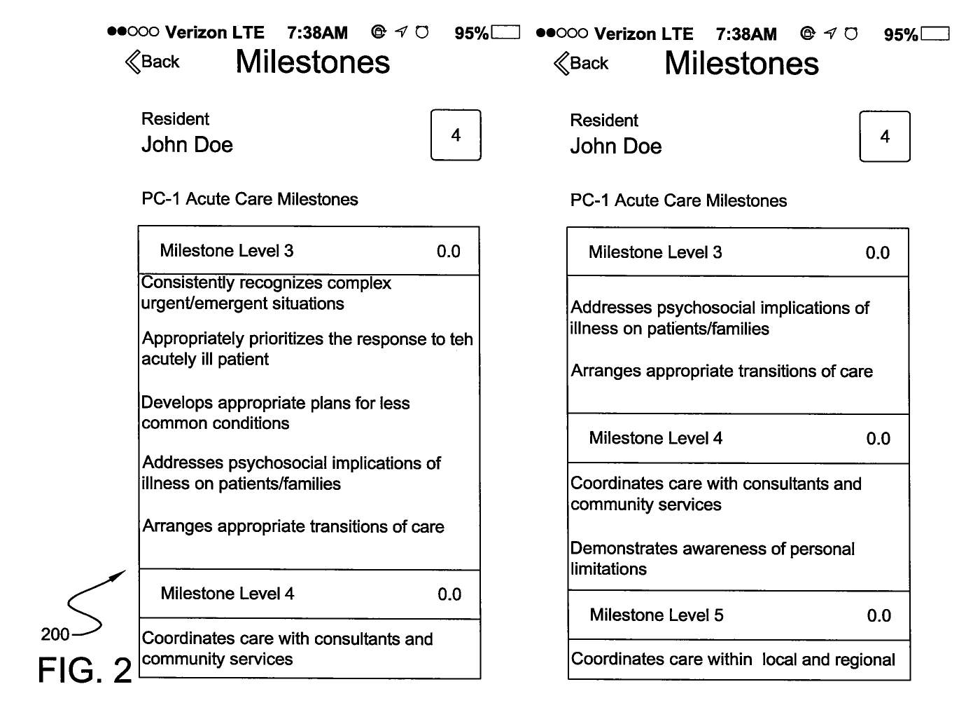

As shown in FIGS. 1-3, the first application is the faculty application, it allows the faculty/educator to quickly and efficiently document the observation of milestone achievements by the student/resident into a live, electronic, quantitative and qualitative database that is accessible to all faculty and learners. The faculty home screen 100 lists all current residents/students in the residency/medical school program. Observations 300 are submitted by first choosing the particular resident/student. The faculty then chooses the particular competency 102, sub-competency, and milestone 200 for the chosen resident/student on successive screens. One or multiple milestones, sub-competencies, and competencies can be reported in the same submission for a particular resident/student. A comment may be typed or dictated with the submission, and is automatically attached to and collated with the milestone and sub-competencies. The quantitative and qualitative data is entered into a shared, electronic database that is frequently updated. The quantitative data submitted automatically updates the resident's milestone achievement level (score) based on the program's chosen customization.

All previously submitted observations and data are live and accessible to the faculty/educator within the milestone submission portion of the faculty application. This allows previously submitted data to be visible to the faculty while making a new milestone submission. Beside each milestone is a number that indicates the number of previous submissions for that milestone. If the number is in a yellow box, the resident is not yet competent in that milestone. If the number is in a green box, the resident has been determined to be competent in that milestone by the program. This live data feedback loop informs the educator how many submissions have already been reported for each milestone and if that particular student has already been determined to be competent in that particular milestone. In other words, the faculty is able to determine, using live data embedded within the milestone submission form itself, if that observation needs to be submitted or if it will be a duplicate, unnecessary submission due to information that is already in the database from past observations.

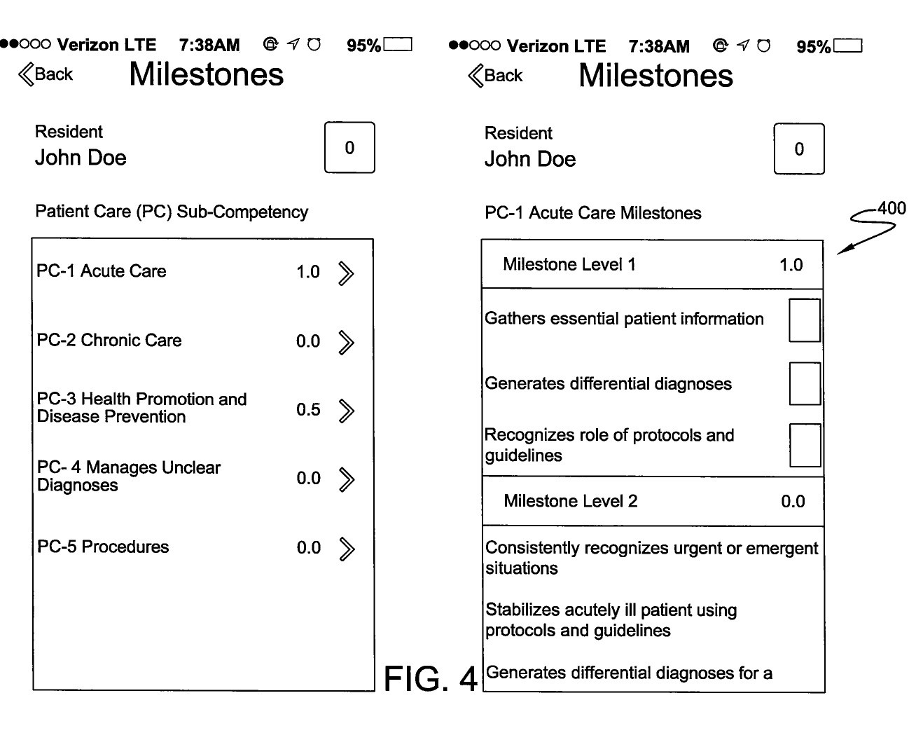

Furthermore as shown in FIG. 4, the teaching program (residency or medical school) is able to customize this feature by choosing the number of times 400 a milestone needs to be observed before competency is granted by the application to the learner for that milestone. When the learner is deemed competent in a milestone, the yellow box turns green within the submission form of the faculty application and alerts the educator to the competency of the learner in that milestone. Of course, other color schemes or signals can be used and/or displayed to convey to the faculty the status of the competency milestone without affecting the overall concept of the present invention.

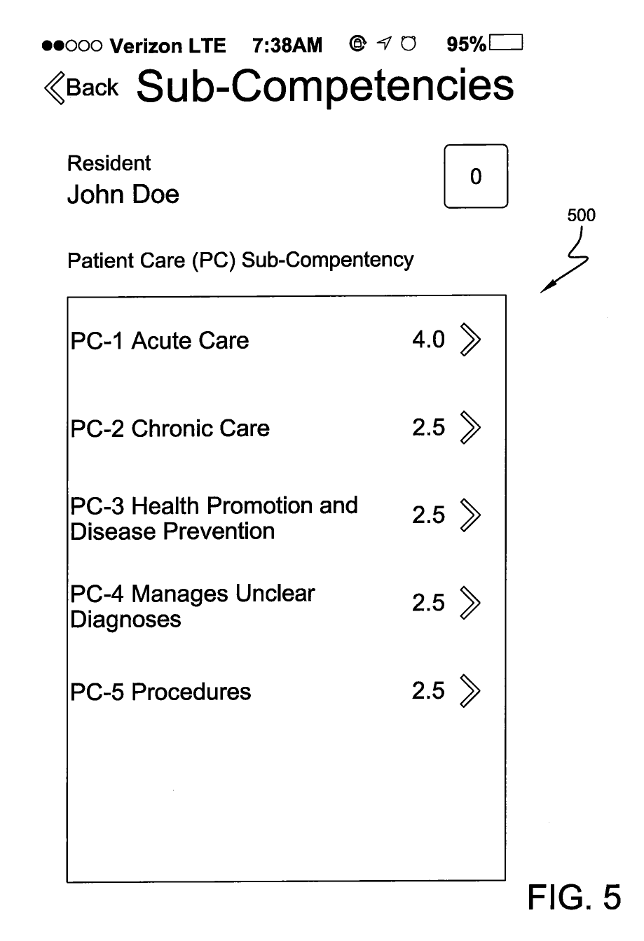

Additionally as shown in FIG. 5, the faculty application comprises sub-competency selection windows 500 within the submission portion of the application. Beside each sub-competency selection window, the level of attainment of the learner in that sub-competency is visible. This is a live data feed from the database that indicates the resident's attained score for that sub-competency. This informs the educator of the resident's level of attainment per ACGME guidelines before making a submission of a milestone observation. It is a functional, live report card built into the documentation and feedback tool of the application.

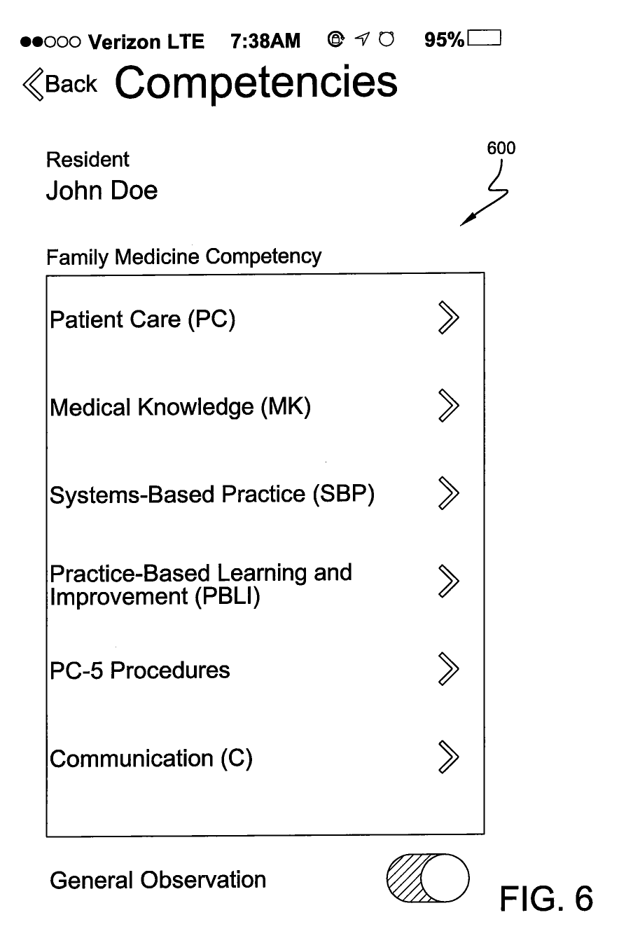

As shown in FIG. 6, the faculty application also allows the educator to provide feedback to the learner without giving credit by submitting a milestone. For example, by using a general observation toggle switch 600, the teacher is able to provide feedback comments to the learner designated by the sub-competency. This feature allows qualitative feedback to be provided without affecting the quantitative data, thus, not affecting the live reporting score within the application or database. Therefore, this type of submission does not alter the milestone submission count, the color of the box described above indicating competence, or the level of sub-competency attainment of the learner.

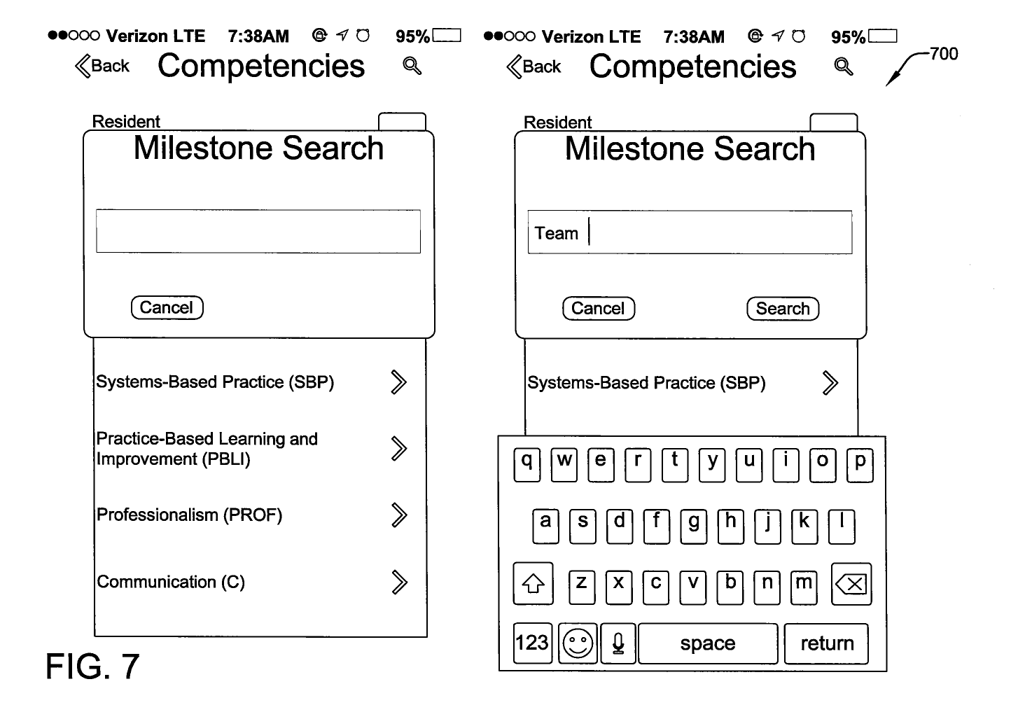

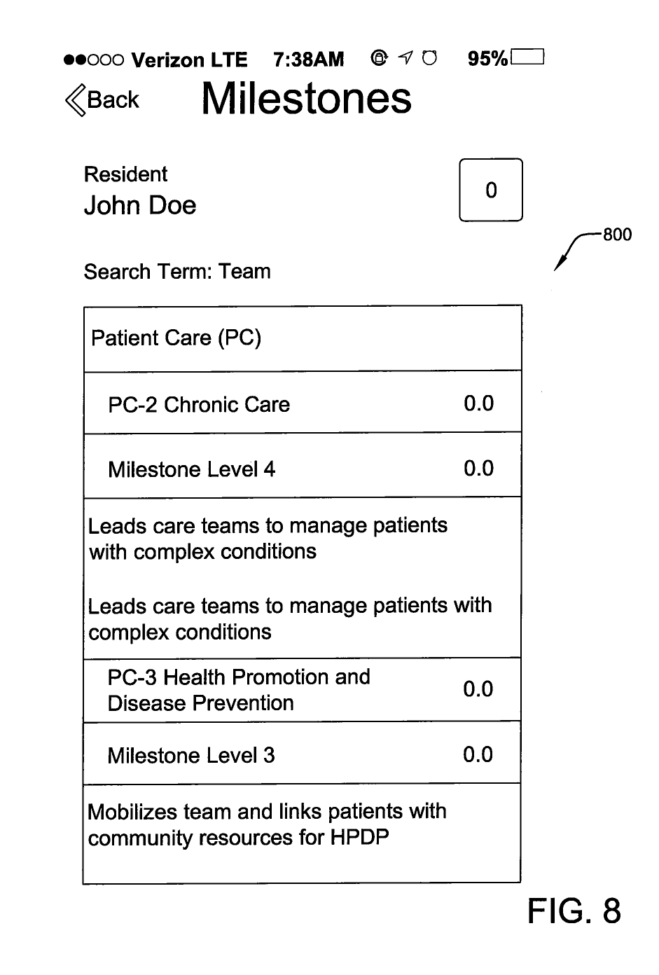

Also as shown in FIGS. 7-8, the faculty application comprises a search feature 700 that enables the user to search the milestone language. This makes all milestones available to the educator by typing or dictating into the search window. Thus, milestones matching the search 800 are made available on one screen designated by competency, sub-competency, and level of milestone. The milestones made available by the search feature also contain information/feedback to the faculty indicating if the resident is competent in that particular milestone. Each milestone can be selected for submission from this screen. The search option searches the original milestone language.

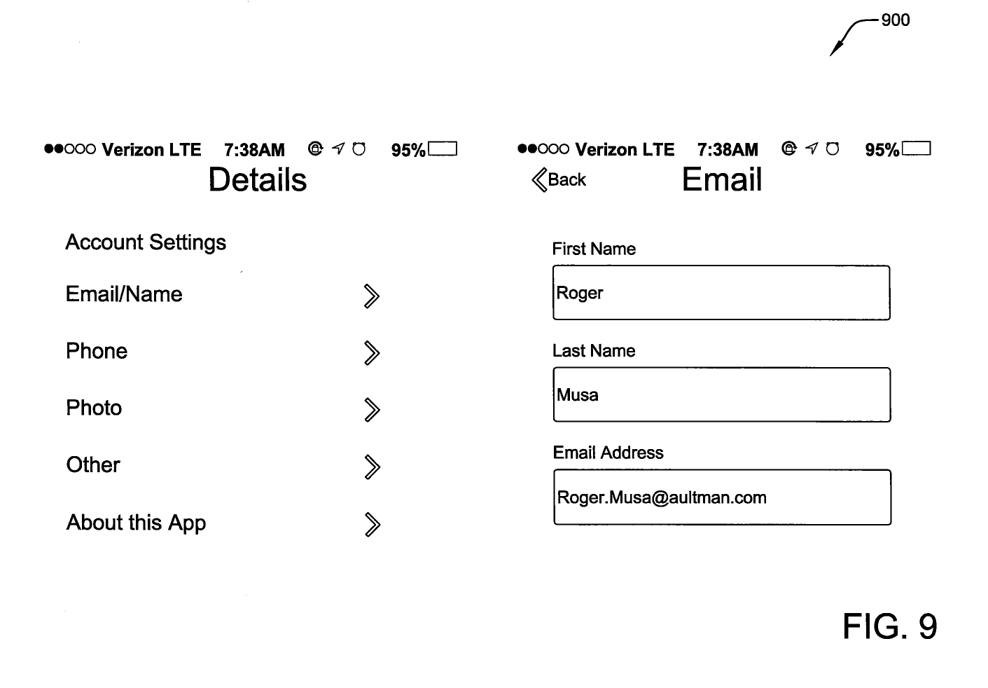

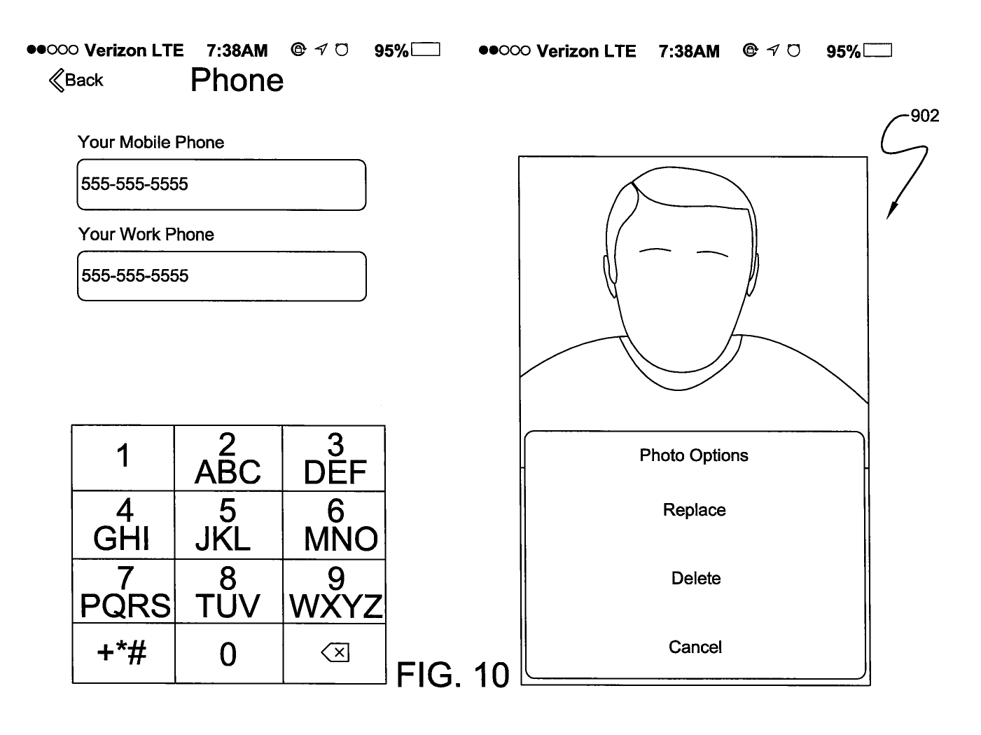

Additionally as shown in FIGS. 9-10, the faculty application allows the educator to enter a learner view 900 that is completely separate from the submission portion of the faculty application. This function accesses the photo, email, phone information, observations, and report of the learner 902. The observation button in the learner view enables the educator to access all prior observations made of that particular resident. This includes the date, the identity of the faculty that made the observation, the credited milestone(s), and the qualitative observation feedback given to the learner/resident. The report button in the learner view enables access to the live, interactive report card for that resident. Opening this view gives access to all the competencies. By selecting a competency, the sub-competencies for that competency are visible. Beside each sub-competency is the current level of attainment (score) for that sub-competency achieved by the resident. By selecting a sub-competency, the milestones for that sub-competency, separated by levels, are visible. Beside each milestone is the number of times that milestone has been submitted for that resident. By choosing a milestone, the date, faculty, and observation comments for all submissions for that milestone are visible, thus creating an interactive report card that is readily available to faculty for all learners/students.

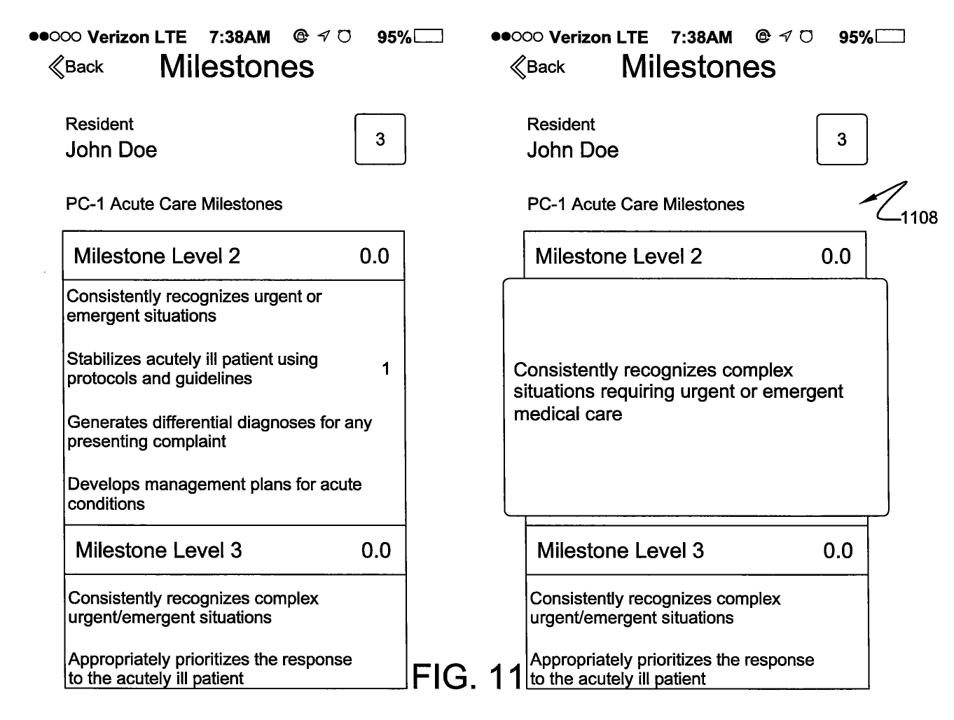

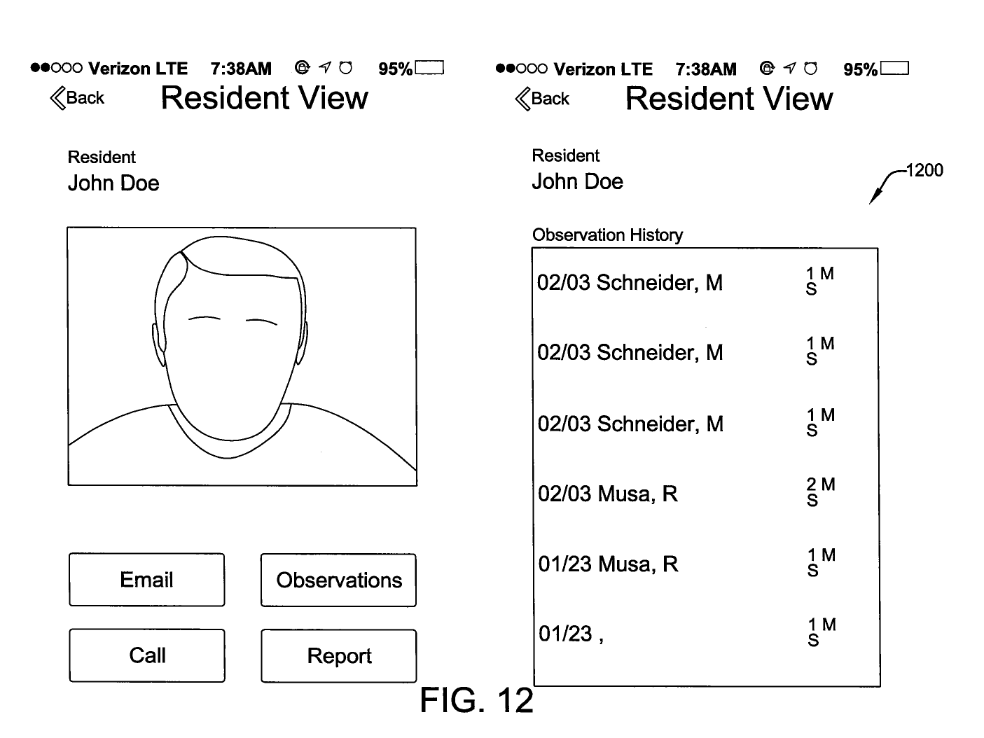

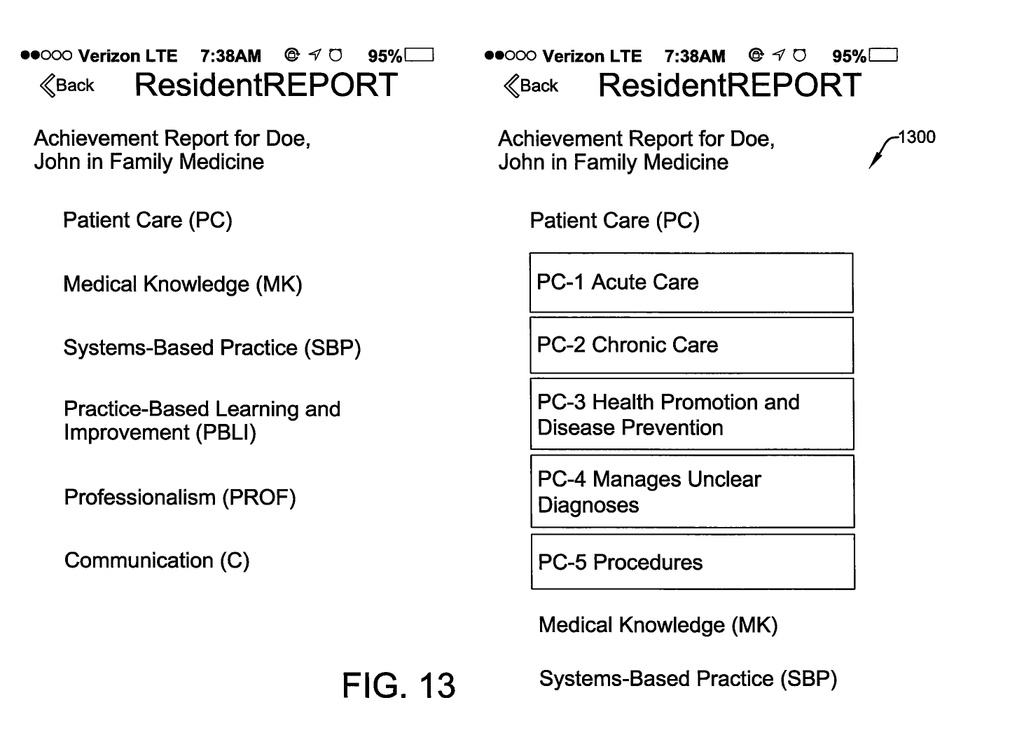

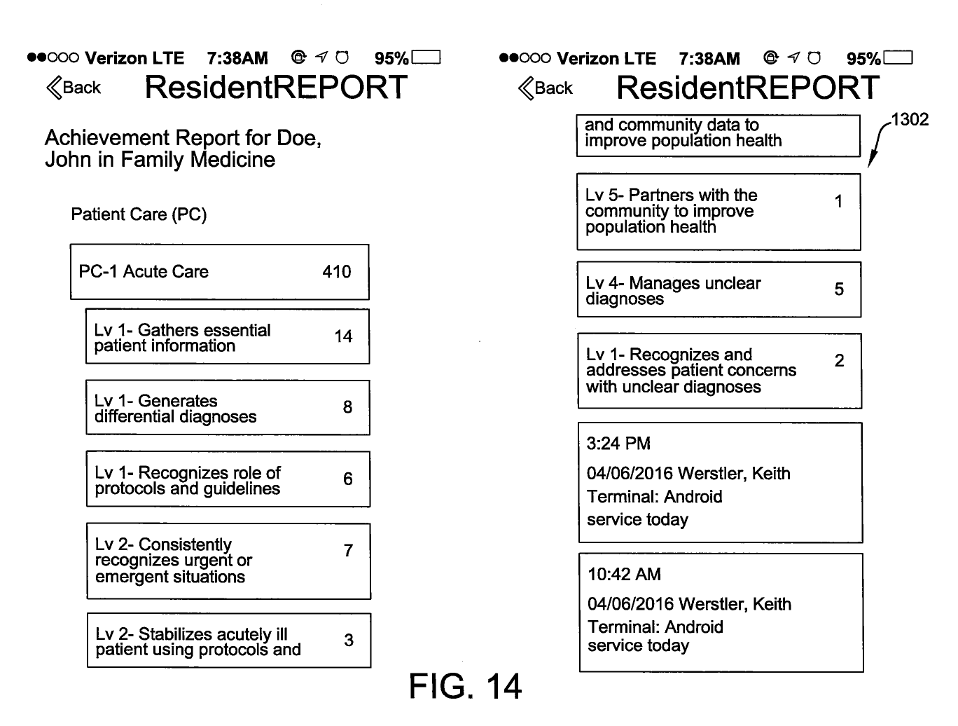

As shown in FIGS. 11-14, the faculty application also comprises a push notification sent from the faculty application to the learner's application. This push notification occurs with every submission and instantly notifies the learner that an observation has been submitted 1100. The learner can access the submission and feedback easily within their application 1200. This efficiently closes the feedback loop from teacher to learner. Additionally, the faculty application allows a user to view the original milestone language by long-holding on any milestone 1300. Long-holding means that instead of tapping the milestone, which selects that milestone to be added, instead the user holds their finger on the milestone longer (about a second). Once a user holds their finger on the milestone, a separate window opens that contains the original language for that milestone. The visible milestones are modified versions of the original text; this is necessary in order to provide succinct, at-a-glance summaries of each milestone. The original text, however, can be quickly viewed by long-holding the milestone as detailed above 1302.

The second application is the learner application that enables the learner to access their live database. By use of the application, the learner receives push notifications of submissions by teachers and is able to receive instantaneous feedback. The learner is also able to view all of his/her own observations submitted by the learner's various teachers. This may be categorized several different ways including by date or by sub-competency. Learners are not able to access other learners' data. Another feature enables the learner to see what milestones are needed to achieve the next attainment level for each sub-competency. Finally, the learner is able to view his/her live sub-competency report card. The learner application does not allow for the submission of milestone observations.

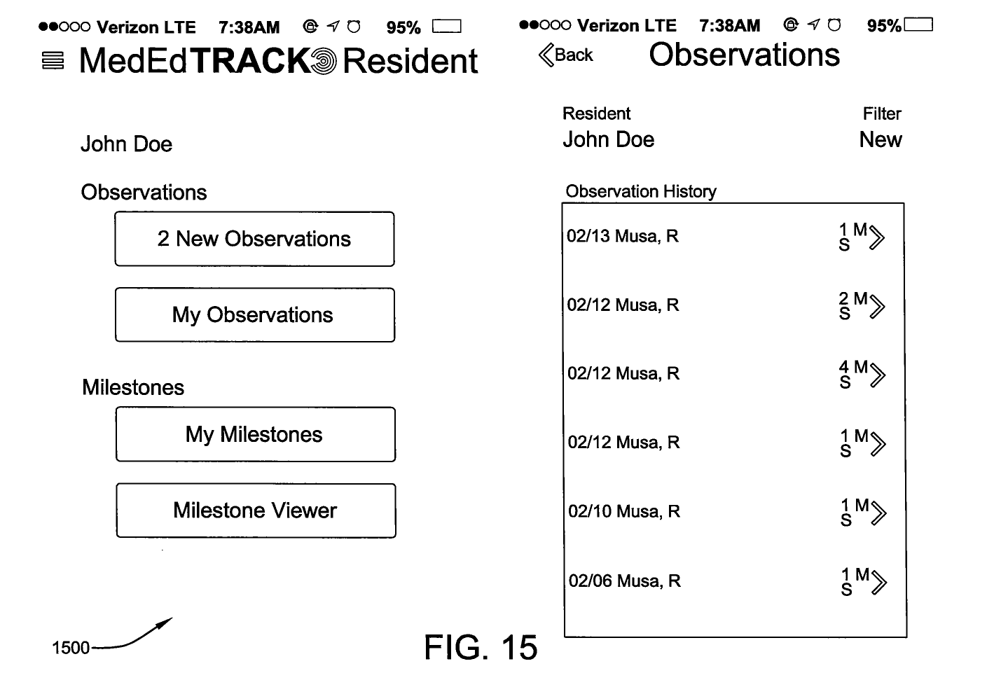

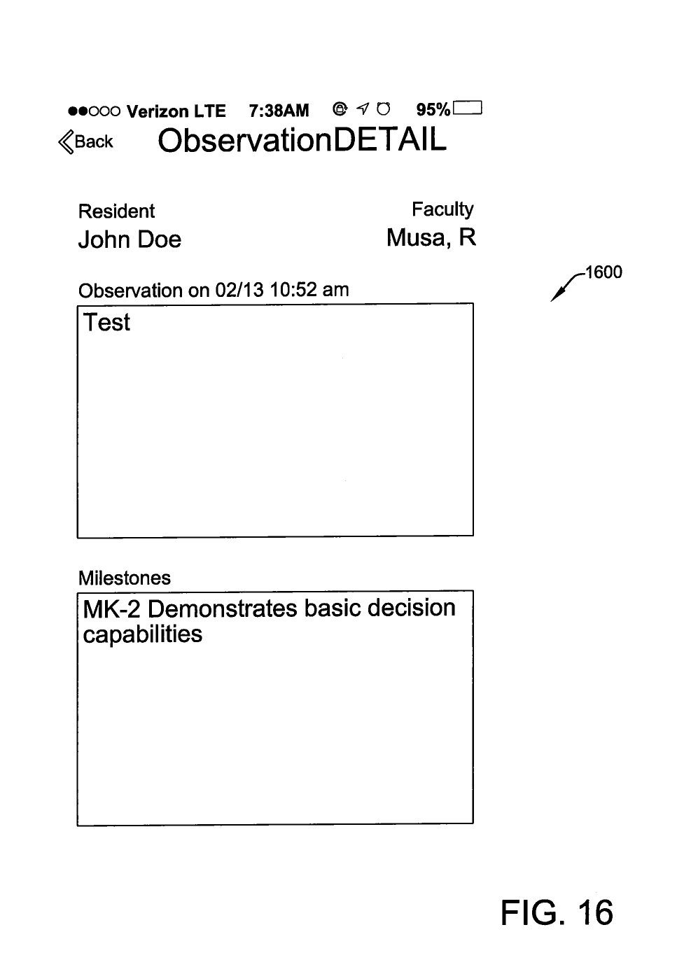

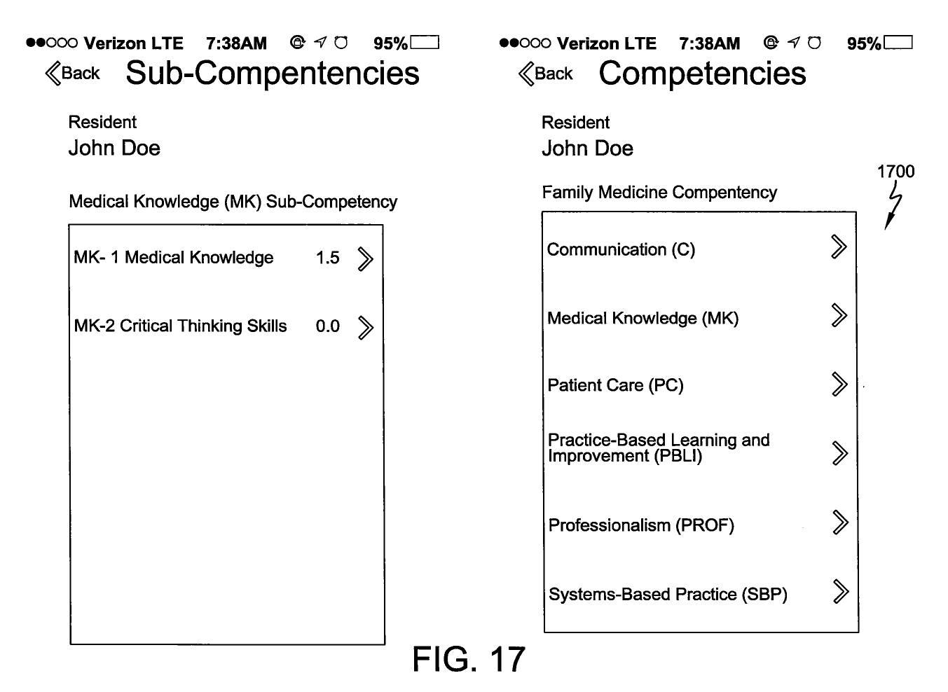

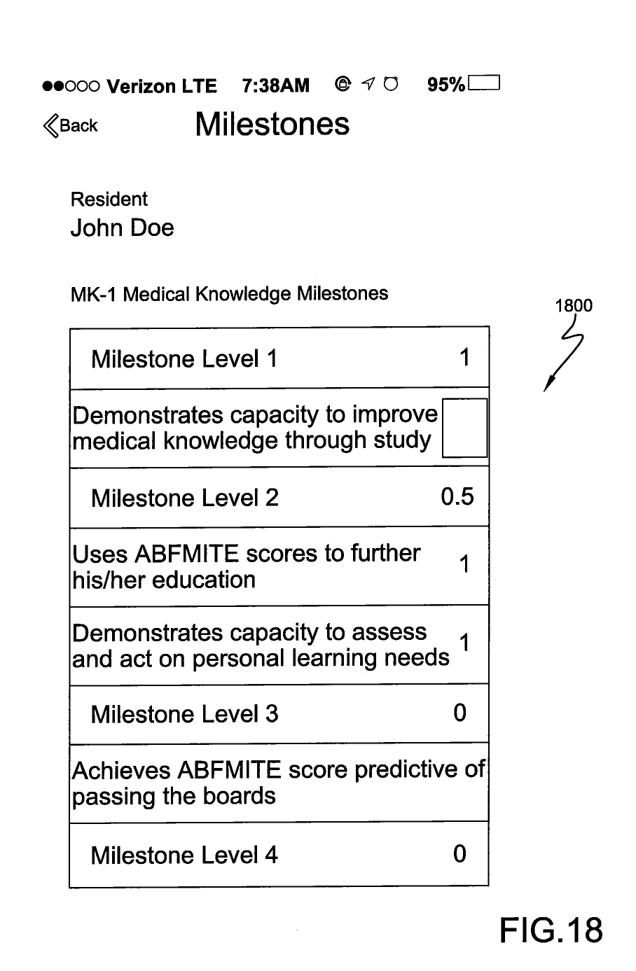

As shown in FIGS. 15-18, when the resident application is opened, it takes the learner to his/her home screen 1500 consisting of four buttons, two each under “Observations” and “Milestones”. The first button opens the screen 1600 with all milestones not previously reviewed by the learner. These are categorized by date with the most recent appearing at the top of the list. Information included is date, the identity of the faculty making the observation, and the number of milestones submitted. Selecting one of the observations opens the observation detail view, which includes the comments and the submitted milestones. The second observation button includes the same information, except it includes all observations, even if previously viewed. A third button labeled “My Milestones” opens a screen that lists the competencies and mirrors the faculty submission application. By selecting a competency the sub-competency screen 1700 is visible and shows the resident level of attainment for each sub-competency, again mirroring the faculty application. Selecting the sub-competency windows opens the milestones screen 1800 that shows each milestone, the number of submissions for each milestone, and indicates whether the learner is competent in that milestone based on the scoring system and customization selected by the program. A yellow box indicates that the resident is not yet competent and a green box indicates competency, again mirroring the faculty application. By selecting the milestone, all the observations for that milestone can be selected for viewing.

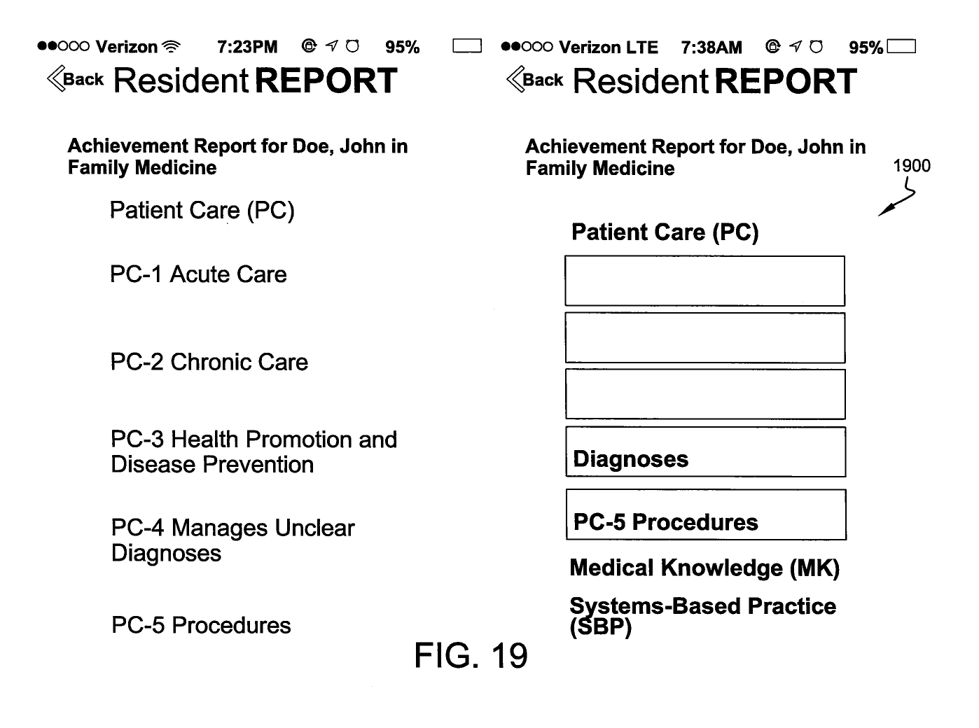

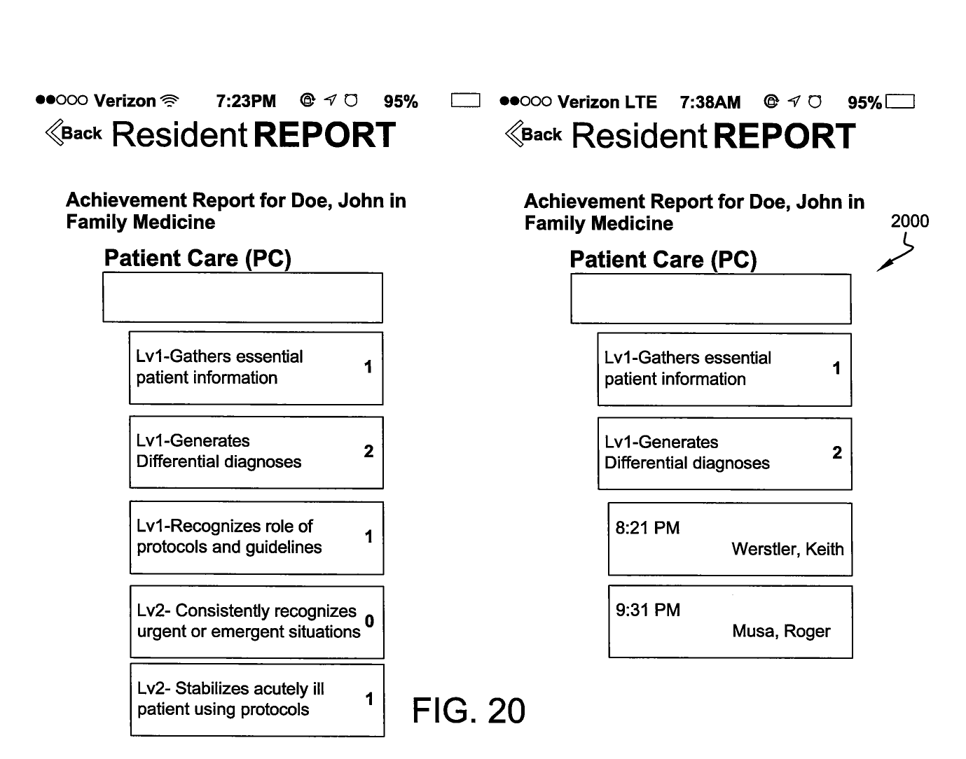

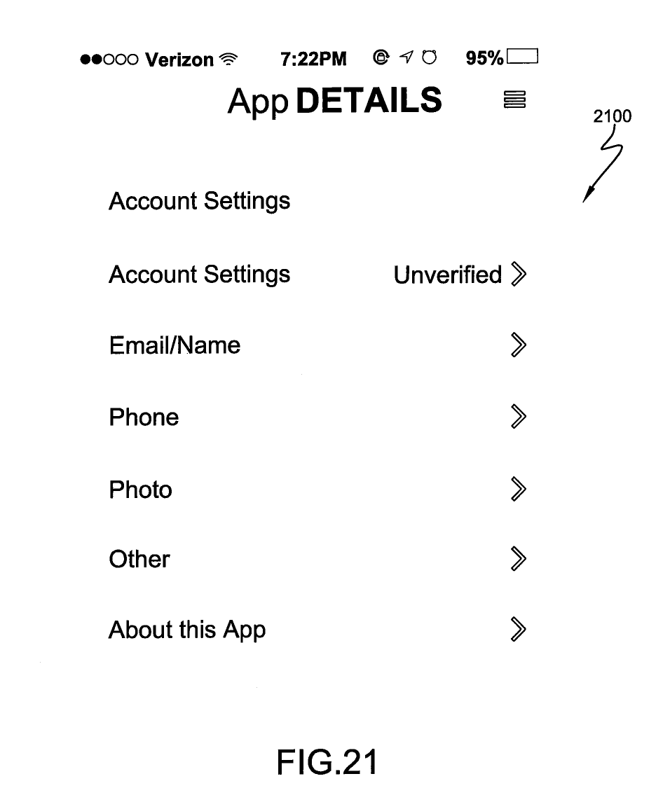

As shown in FIGS. 19-20, the last button on the resident home screen is the “Milestone Viewer”. This enables access to the live, interactive report card for that resident. Opening this view gives access to all the competencies. By selecting a competency, the sub-competencies for that competency are visible 1900. Beside each sub-competency is the current level of attainment (score) for that sub-competency achieved by the resident. By selecting a sub-competency, the milestones for that sub-competency, separated by levels, are visible 2000. Beside each milestone is the number of times that milestone has been submitted for that resident. By choosing a milestone, the date, faculty, and observation comments for all submissions for that milestone are visible. This interactive report card is always a live, current report card with up-to-date information. As shown in FIG. 21, the resident application also has an AppDetails section 2100 that allows the resident to verify their email and update contact information.

The mobile applications work in conjunction with a remote server. The server communicates with a database that holds a number of tables that are related and sortable. The tables hold hierarchical information that allows for the efficient computing of a medical resident's achievement levels within a particular sub-competency.

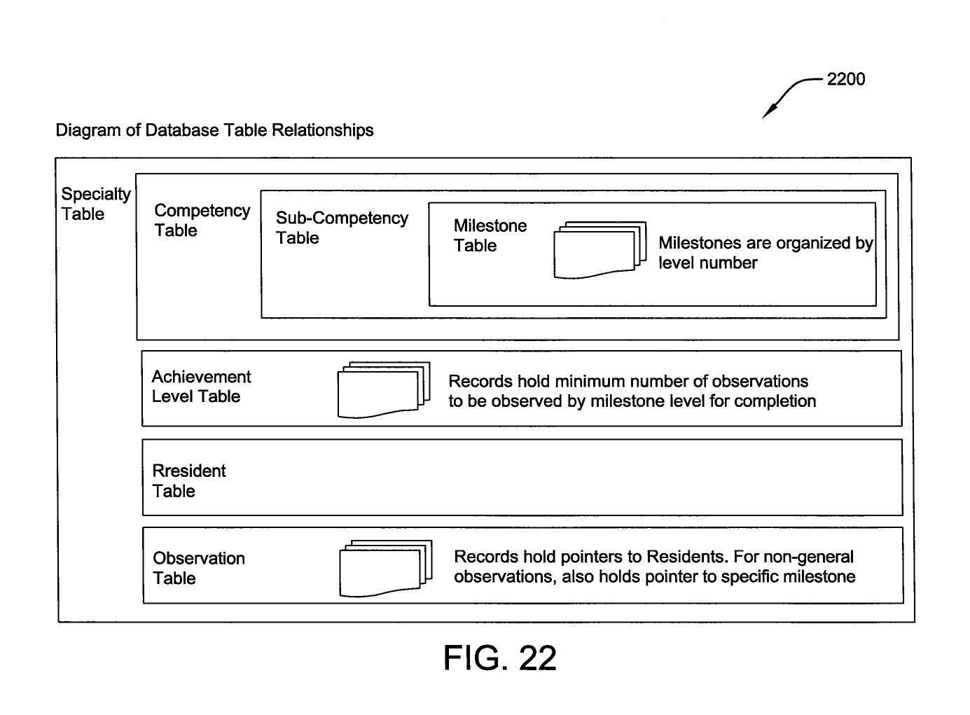

In FIG. 22, the hierarchical relationships are explained 2200. These relationships allow for both general and specific observations to be recorded by an instructor for a particular medical resident. General observations are not counted towards completion of a particular milestone level. Instead the general observations are used to provide constructive criticism to the medical resident for the particular sub-competency that it was recorded under.

Specific observations are recorded under a particular milestone description. Milestones are organized by levels and each level requires a minimum number of observations to be considered complete. This grading practice is performed in accordance with guidelines set forth by ACGME.

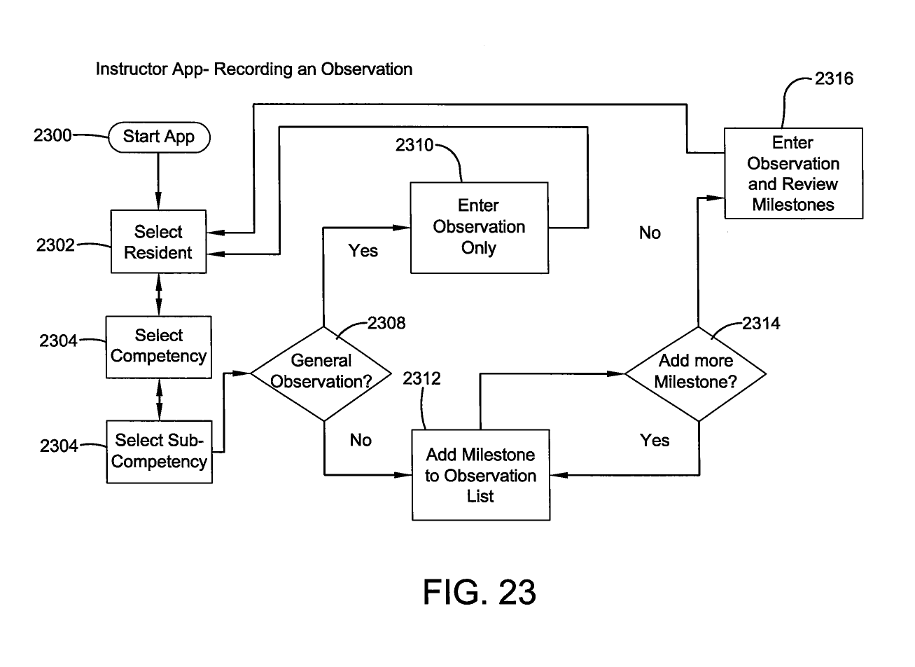

FIG. 23 shows the steps used by the application of the present invention to record an observation, which could be a general or specific observation. Since general observations are recorded under a particular sub-competency and are not associated with any one particular milestone, the checkout process is simplified. For specific observations, any number of milestones can be attached to the observation, including those that may be under different sub-competencies.

Furthermore, during the checkout process, a JSON data array of milestones, observations, faculty, device ID and resident information is transmitted via HTTPS to a computer server that in addition to checking the validity of the device, saves the data into a SQL database. The data is indexed by resident, by milestone, by faculty and by date and time. Upon a successful save to the database, a semaphore is sent back to the application signaling its completion. Also a push notification is sent to the registered devices of the particular resident, notifying the resident that one or more observations have been recorded by the faculty member.

Specifically, the process begins at 2300, then at 2302 a resident is selected. At 2304, a competency is selected and at 2306 a sub-competency is selected. At 2308 it is determined if a general observation is being entered, if yes, then at 2310 the general observation is entered and the process is completed and/or started from the beginning depending on a user's need. If the observation is not general, then at 2312 the milestone is added to the observation list. At 2314, it is determined whether to add more milestones. If yes, then the process returns to 2312 to add the milestones to the observation list. If no, then at 2316 the observation is entered and the milestones reviewed. Once the selection of milestones has been completed, the application will take the user to a checkout screen where the observation can be entered and the milestones selected can be reviewed and edited. The process is then completed and/or started from the beginning depending on a user's need.

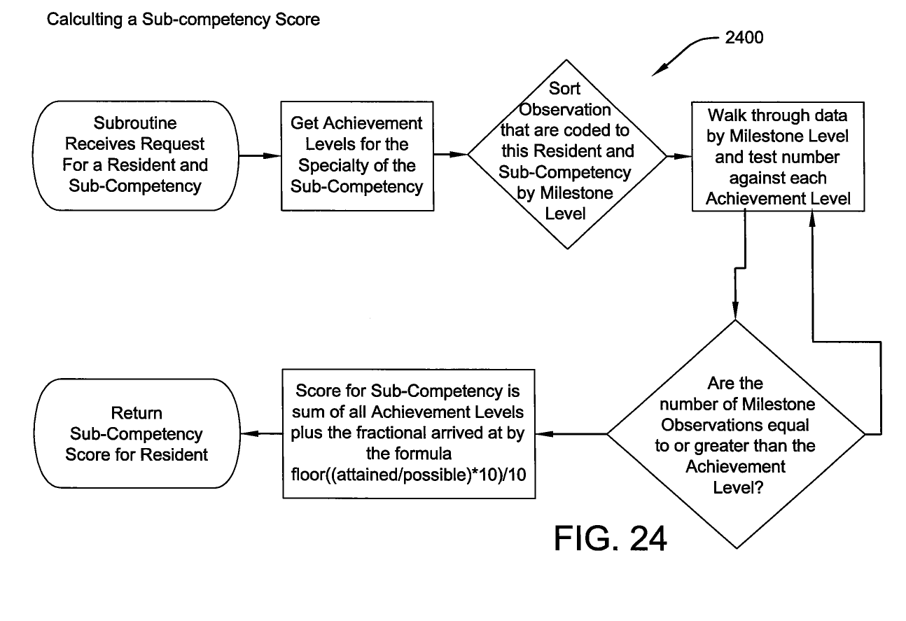

Because of the use of both general and specific observations, a method for calculating achievement scores for sub-competencies 2400 was devised and is shown in FIG. 24. General observations are not counted toward the achievement levels.

To calculate an achievement score for a particular resident, the observation table is sorted for those coded to that resident and for that particular sub-competency by milestone level. The resulting data is then walked-through by milestone level and tested against the minimum required observations for that milestone level. If the minimum observations for that level have been met the algorithm continues to walk through the data. At the first level where there is a shortfall between the number of observations and the number required, the system will then compute the fractional achievement score. The formula for this fraction is the following:

Fractional Achievement=(floor(2*(attained observations/required observations))/2)

The fractional amount is then added to the previous levels for an overall achievement score. See Example 1 below for a complete description of this computation method using sample data.

Furthermore, the data to compute the scores is extracted from a cloud-based SQL database that holds the milestone and observation data by resident, by sub-competency and competency. The data is extracted by a networked computer server and the scoring takes place as a server-side activity. The scores, after computation, are then transmitted via a JSON data array to the appropriate application.

Additionally, the method of computing the achievement score and recording the observations has been implemented and tested using mobile devices running an application that communicates with one or more remote servers. The servers are storing the information recorded in a database that allows for convenient and efficient sorting and indexing. An administrative web server is also utilized to allow for table updates and various maintenance and administrative functions.

TABLE 1
Example 1
Sample Achievement Level Table for a Particular Specialty

| | Minimum Number of |
|---|---|
| Milestone Levels | Observations per Milestone |
| 1 | 1 |
| 2 | 2 |
| 3 | 3 |
| 4 | 3 |
| 5 | 1 |

TABLE 2
Sample Observation Table for a Particular
Resident for a Sub-Competency

| Observation ID | Milestone ID | Milestone Level |
|---|---|---|
| 1 | 22 | 1 |
| 2 | 23 | 2 |
| 3 | 23 | 2 |
| 4 | 24 | 3 |
| 5 | 24 | 3 |

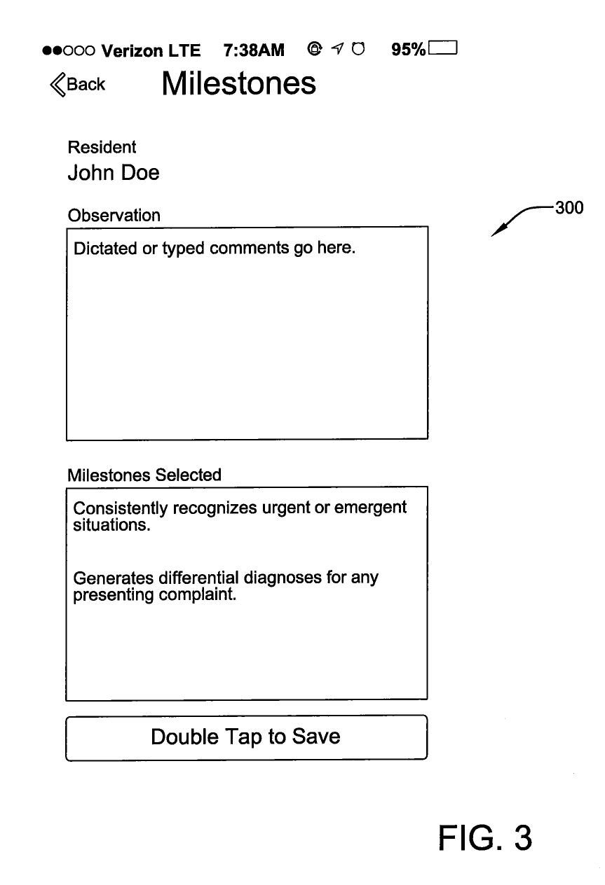

For this particular example, in the sample observation table (Table 2) there are five observations attributed to three milestones. Using the computation method as described in FIG. 3 and the achievement level data shown in Table 1, the following computation would take place.

There is one observation for milestone level 1 and the achievement table requires 1 for completion, so level 1 is complete and the achievement score is set to 1.

There are two observations for milestone level 2 and the achievement table requires 2 for completion, so level 2 is complete and the achievement score is incremented by 1 to a total of 2.

There are two observations for milestone level 3 and the achievement table requires 3 for completion, so level 3 is not complete and according to the formula, the fractional remainder is (floor(2*(2/3))/2) or 0.5. Since level 3 was not completed, there will be no additional consideration of observations beyond this level. The fractional amount is added to the achievement score for a total of 2.5. This value is returned to the user as the achievement score for this particular sub-competency.

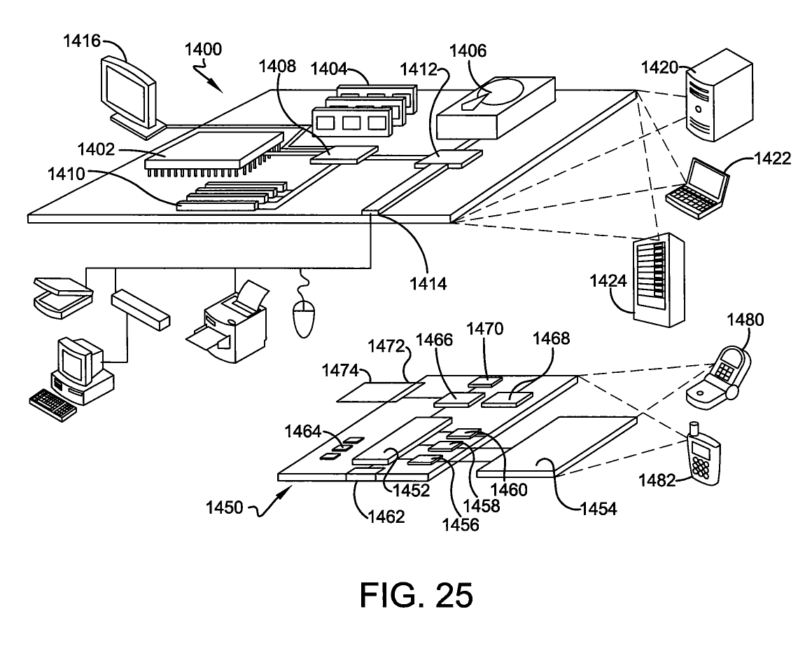

FIG. 25 shows an example of a generic computer device 1400 and a generic mobile computer device 1450, which may be used to implement the processes described herein, including the mobile-side and server-side processes for installing a computer program from a mobile device to a computer. Computing device 1400 is intended to represent various forms of digital computers, such as laptops, desktops, workstations, personal digital assistants, servers, blade servers, mainframes, and other appropriate computers. Computing device 1450 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Furthermore, the above-described system was conceived primarily as a cloud-based platform. Thus, the computation instances are virtual machines that are running with thousands of other virtual machines inside of a rack-based server cluster.

Computing device 1400 includes a processor 1402, memory 1404, a storage device 1406, a high-speed interface 1408 connecting to memory 1404 and high-speed expansion ports 1410, and a low speed interface 1412 connecting to low speed bus 1414 and storage device 1406. Each of the components 1402, 1404, 1406, 1408, 1410, and 1412 are interconnected using various busses, and may be mounted on a common motherboard or in other manners as appropriate. The processor 1402 can process instructions for execution within the computing device 1400, including instructions stored in the memory 1404 or on the storage device 1406 to display graphical information for a GUI on an external input/output device, such as display 1416 coupled to high speed interface 1408. In other implementations, multiple processors and/or multiple busses may be used, as appropriate, along with multiple memories and types of memory. Also, multiple computing devices 1400 may be connected, with each device providing portions of the necessary operations (e.g., as a server bank, a group of blade servers, or a multi-processor system).

The memory 1404 stores information within the computing device 1400. In one implementation, the memory 1404 is a volatile memory unit or units. In another implementation, the memory 1404 is a non-volatile memory unit or units. The memory 1404 may also be another form of computer-readable medium, such as a magnetic or optical disk.

The storage device 1406 is capable of providing mass storage for the computing device 1400. In one implementation, the storage device 1406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable storage medium, such as the memory 1404, the storage device 1406, or memory on processor 1402.

The high speed controller 1408 manages bandwidth-intensive operations for the computing device 1400, while the low speed controller 1412 manages lower bandwidth-intensive operations. Such allocation of functions is exemplary only. In one implementation, the high-speed controller 1408 is coupled to memory 1404, display 1416 (e.g., through a graphics processor or accelerator), and to high-speed expansion ports 1410, which may accept various expansion cards (not shown). In the implementation, low-speed controller 1412 is coupled to storage device 1406 and low-speed expansion port 1414. The low-speed expansion port 1414, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter. Furthermore, given the cloud-based nature of the server and database, the administrative and user websites are only available via an internet browser connection and any end-user peripherals would be connected to the PC that is the browser and not to the server.

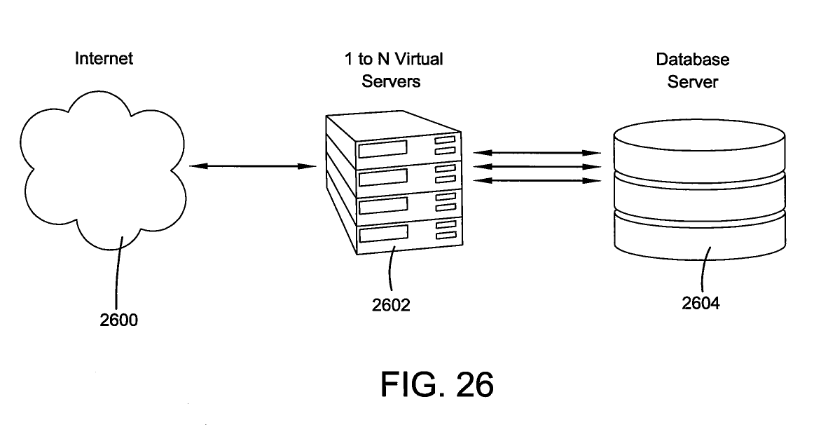

Furthermore as shown in FIG. 26, if the system utilizes a cloud-based platform (see 2600), then the database is a separate service from the server service. This allows the servers to scale from 1 to N depending upon demand (see 2602). As such, the database server 2604 is a special-purpose server that just attends to database transactions via networked connections. And, there is generally a many-to-one relationship in terms of servers to database servers.

Additionally as shown in FIG. 25, the computing device 1400 may be implemented in a number of different forms. For example, it may be implemented as a standard server 1420, or multiple times in a group of such servers. It may also be implemented as part of a rack server system 1424. In addition, it may be implemented in a personal computer such as a laptop computer 1422. Alternatively, components from computing device 1400 may be combined with other components in a mobile device (not shown), such as device 1450. Each of such devices may contain one or more of computing device 1400, 1450, and an entire system may be made up of multiple computing devices 1400, 1450 communicating with each other.

Computing device 1450 includes a processor 1452, memory 1464, an input/output device such as a display 1454, a communication interface 1466, and a transceiver 1468, among other components. The device 1450 may also be provided with a storage device, such as a micro-drive or other device, to provide additional storage. Each of the components 1450, 1452, 1464, 1454, 1466, and 1468 are interconnected using various busses, and several of the components may be mounted on a common motherboard or in other manners as appropriate.

The processor 1452 can execute instructions within the computing device 1450, including instructions stored in the memory 1464. The processor may be implemented as a chipset of chips that include separate and multiple analog and digital processors. The processor may provide, for example, for coordination of the other components of the device 1450, such as control of user interfaces, applications run by device 1450, and wireless communication by device 1450.

Processor 1452 may communicate with a user through control interface 1458 and display interface 1456 coupled to a display 1454. The display 1454 may be, for example, a TFT LCD (Thin-Film-Transistor Liquid Crystal Display) or an OLED (Organic Light Emitting Diode) display, or other appropriate display technology. The display interface 1456 may comprise appropriate circuitry for driving the display 1454 to present graphical and other information to a user. The control interface 1458 may receive commands from a user and convert them for submission to the processor 1452. In addition, an external interface 1462 may be provided in communication with processor 1452, so as to enable near area communication of device 1450 with other devices. External interface 1462 may provide, for example, for wired communication in some implementations, or for wireless communication in other implementations, and multiple interfaces may also be used.

The memory 1464 stores information within the computing device 1450. The memory 1464 can be implemented as one or more of a computer-readable medium or media, a volatile memory unit or units, or a non-volatile memory unit or units. Expansion memory 1474 may also be provided and connected to device 1450 through expansion interface 1472, which may include, for example, a SIMM (Single In Line Memory Module) card interface. Such expansion memory 1474 may provide extra storage space for device 1450, or may also store applications or other information for device 1450. Specifically, expansion memory 1474 may include instructions to carry out or supplement the processes described above, and may include secure information also. Thus, for example, expansion memory 1474 may be provide as a security module for device 1450, and may be programmed with instructions that permit secure use of device 1450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1464, expansion memory 1474, memory on processor 1452, or a propagated signal that may be received, for example, over transceiver 1468 or external interface 1462.

Device 1450 may communicate wirelessly through communication interface 1466, which may include digital signal processing circuitry where necessary. Communication interface 1466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1468. In addition, short-range communication may occur, such as using a Bluetooth, Wi-Fi, or other such transceiver (not shown). In addition, GPS (Global Positioning System) receiver module 1470 may provide additional navigation- and location-related wireless data to device 1450, which may be used as appropriate by applications running on device 1450.

Device 1450 may also communicate audibly using audio code 1460, which may receive spoken information from a user and convert it to usable digital information. Audio code 1460 may likewise generate audible sound for a user, such as through a speaker, e.g., in a handset of device 1450. Such sound may include sound from voice telephone calls, may include recorded sound (e.g., voice messages, music files, etc.) and may also include sound generated by applications operating on device 1450.

The computing device 1450 may be implemented in a number of different forms, as shown in the figure. For example, it may be implemented as a cellular telephone 1480. It may also be implemented as part of a smartphone 1482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

Other implementations not specifically described herein are also within the scope of the following claims.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of recording observations and calculating achievement levels performed by one or more processing devices, said method comprising the steps of:
utilizing two mobile applications working in conjunction with a live database on a remote server;
the two mobile applications communicating with the live database which holds a number of tables that are related and sortable;
allowing users to read and write to a live database which allows for sharing of data in real time; and
allowing the two mobile applications to interact with each other via push notifications.

2. The method of claim 1, wherein the first mobile application is used by faculty educators in residency programs or medical schools and allows for the input of resident or student data relating to the observation of milestones as required by each residency specialty as mandated by The Accreditation Council of Graduate Medical Education.

3. The method of claim 1, wherein the second mobile application is used by medical residents or students to access their milestone observations and is used as a live report card documenting their current level of attainment.

4. The method of claim 1, wherein the database is accessible to a licensed individual via a web-based administrative site.

5. The method of claim 1, further comprising:
allowing a program to determine a minimum number of observations required for a milestone level in order to achieve competency;
allowing a program to manually establish sub-competency levels for any resident; and
calculating an achievement score for a particular resident.

6. The method of claim 5, wherein general observations are not counted for completion of a particular milestone level.

7. The method of claim 5, wherein specific observations are recorded under a particular milestone description.

8. The method of claim 5, wherein milestones are organized by levels and a level requires a minimum number of observations to be considered complete.

9. The method of claim 8, further comprising:
selecting a resident;
selecting a competency;
selecting a sub-competency; and
recording an observation.

10. One or more storage devices storing instructions that are executable to perform operations, comprising:
utilizing two mobile applications working in conjunction with a live database on a remote server;
communicating with a database which holds a number of tables that are related and sortable;
allowing users to read and write to the database which allows for sharing of data in real time; and
allowing the two applications to interact with each other via push notifications.

11. The method of claim 10, wherein a first application is used by faculty educators in residency programs or medical schools and allows for input of resident or student data relating to an observation of milestones as required by each residency specialty as mandated by The Accreditation Council of Graduate Medical Education (ACGME).

12. The method of claim 10, wherein a second application is used by medical residents or students to access milestone observations and is used as a live report card documenting a current level of attainment.

13. The method of claim 10, wherein a database is accessible to licensed individuals via a web-based administrative site.

14. The method of claim 10, further comprising:
allowing a program to determine a minimum number of observations required for each milestone level in order to achieve “competency”;
allowing a program to manually establish sub-competency levels for any resident; and
calculating an achievement score for a particular resident.

15. The method of claim 14, further comprising:
to calculate an achievement score for a particular resident, sorting an observation table for those coded to that resident and for that particular sub-competency by milestone level; and
walking-through resulting data by milestone level and testing against a minimum required observations for a milestone level.

16. The method of claim 15, further comprising:
if a minimum observations for a level have been met, continuing to walk-through the data;
at a first level where there is a shortfall between a number of observations and a number required, computing a fractional achievement score; and
adding a fractional amount to previous levels for an overall achievement score.

17. A method of recording observations and calculating achievement levels performed by one or more processing devices, comprising:
utilizing two mobile applications working in conjunction with a live database on a remote server;
communicating with a database which holds a number of tables that are related and sortable;
allowing users to read and write to a database which allows for sharing of data in real time; and
allowing the two applications to interact with each other via push notifications.

18. The method of claim 17, further comprising:
allowing a program to determine a minimum number of observations required for each milestone level in order to achieve “competency”;
allowing a program to manually establish sub-competency levels for any resident; and
calculating an achievement score for a particular resident.

19. The method of claim 18, further comprising:
to calculate an achievement score for a particular resident, sorting an observation table for those coded to that resident and for that particular sub-competency by milestone level; and
walking-through resulting data by milestone level and testing against a minimum required observations for a milestone level.

20. The method of claim 19, further comprising:
if a minimum observations for a level have been met, continuing to walk-through the data;
at a first level where there is a shortfall between a number of observations and a number required, computing a fractional achievement score; and
adding a fractional amount to a previous level for an overall achievement score.
